(19) United States
(12) Patent Application Publication
(10) Pub. No.: US 2005/0100072 A1
(43) Pub. Date: May 12, 2005

(54) High power laser output beam energy density reduction

(76) Inventors: Rajasekhar M. Rao, San Diego, CA (US); Weiman Zhang, San Diego, CA (US); James K. Howey, Vista, CA (US); Gamaralalage G. Padmabandu, San Diego, CA (US); Paolo Zambon, San Diego, CA (US); Richard L. Sandstrom, Encinitas, CA (US)

Correspondence Address: William Cray;C/o Cymer, Inc., Legal Dept. MS/4-2C, 17075 Thornmint Court, San Diego, CA, 92127, US

(21) Appl. No.: 10/925,746

(22) Filed: Aug. 24, 2004

Related U.S. Application Data
(63) Continuation-in-part of application No. 10/384,967, filed on Mar. 8, 2003.
(63) Continuation-in-part of application No. 10/631,349, filed on Jul. 30, 2003.
(63) Continuation-in-part of application No. 10/425,361, filed on Apr. 29, 2003.
(63) Continuation-in-part of application No. 10/000,991, filed on Nov. 14, 2001, now Pat. No. 6,795,474.

(51) Int. Cl. H01S 3/22

(52) U.S. Cl. 372/55; 372/9

(57) ABSTRACT

A high power gas discharge laser for and method of producing laser output light pulses of high energy density is disclosed which may comprise a laser output light pulse beam optical track having a plurality of modular components arranged in order from a laser light source to a laser system output port and defining a laser output light pulse beam path having a single centerline axis; a first optical module and a second optical module in series in the optical track; a flexible interface element intermediate the first and the second optical module and rigidly attached to each of the first and second optical modules; and an optical element having a fixed position in the output laser pulse beam path comprising a rigid attachment to the first optical module, and extending within the flexible interface element. The optical element may comprise a beam expander, which may comprise a lensed beam expander. The optical element may comprise at least a part of a telescoping lens set forming an optical beam expander and the at least a part of a telescoping lens set comprises the entire telescoping lens set forming the optical beam expander or the at least a part of a telescoping lens set may comprise a first part of the beam expander cooperating with at least a second part located in a subsequent optical module in the laser output pulse beam optical track along the same optical centerline axis. A plurality of aligning mechanisms may align the optical element to a first and a second axis of the laser output pulse beam, the first and second axes being generally orthogonal to each other and orthogonal to the optical centerline axis, and also along the optical centerline axis. The beam expander may incorporate as one optic the output coupler optic and may have a moveable lens to enable a range of magnifications.

### RELATED APPLICATIONS

This application is a continuation-in-part of co-pending U.S. patent application Ser. Nos. 10/384,967, filed on Mar. 8, 2003, Published on Nov. 27, 2003, Publication No. 2003/0219056, entitled HIGH POWER DEEP ULTRAVIOLET LASER WITH LONG LIFE OPTICS, Attorney Docket No. 2003-0005-02, and 10/631,349, filed on Jul. 30, 2003, Published on Mar. 25, 2004, Pub. No. 2004/0057489, entitled CONTROL SYSTEM FOR A TWO CHAMBER GAS DISCHARGE LASER, Attorney Docket No. 2003-0025-02, 10/425,361, filed on Apr. 29, 2003, published on Feb. 5, 2004, Pub. No. 2004/0022291, entitled LITHOGRAPHY LASER WITH BEAM DELIVERY AND BEAM POINTING CONTROL, Attorney Docket No. 2003-0040-01, and 10/000,991, filed on Nov. 14, 2001, entitled GAS DISCHARGE LASER WITH IMPROVED BEAM PATH, Attorney Docket No. 2001-0077-01, and is related U.S. Pat. No. 5,970,082, entitled VERY NARROW BAND LASER, issued to Ershov on Oct. 19, 1999, based on an Application Ser. No. 9/886,715, filed on Jul. 1, 1997, each of which is assigned to the assignee of the present application and the disclosures of each of which are hereby incorporated by reference.

### FIELD OF THE INVENTION

The present invention relates to high power lasers, e.g., gas discharge lasers, utilized for the purposes of providing a light source for a working tool, e.g., an integrated circuit manufacturing lithography tool, containing optical elements sensitive to sustained exposure of high energy density fluences, particularly in very short wavelength of the light provided by the light source, e.g., DUV and VUV light, i.e., below about 300 nm in wavelength.

### BACKGROUND OF THE INVENTION

With regard to energy density state of the art lasers, e.g., applicants' assignee's soon to be introduced 7010 series of single chambered gas discharge laser systems, e.g., ArF, KrF and also including molecular fluorine laser systems can have a beam size of, e.g., 2.4 mm×15.5 mm, with a nominal pulse energy of, e.g., 10 mJ and a measures or calculated energy density on the order of about 70 mJ/cm² of more. It is also well known that for certain applications of output laser light pulses from such lasers, particularly as the output wavelength decreases further and further into the DUV and VUV ranges, such high energy densities, while desirable from a dose and throughput perspective may be undesirable, e.g., from a peak power standpoint. Efforts have been made to address these issues, e.g., with pulse stretching, as discussed in the above referenced co-pending patent applications of applicants' assignee, to expand the output laser light pulses temporally to obtain a better T_{IS} and, therefore, reduced peak pulse energy and reduced energy density with time. But this in turn adds the problem that the pulse stretching optics themselves need to be protected from high fluence. Furthermore, as laser outputs go to 60W and more, the laser light output pulse energy density is not reduced enough even with pulse stretching. It is therefore necessary to reduce pulse energy from, e.g., the above noted exemplary 70 or more mJ/cm² to almost half of that, e.g., 35-40 mJ/cm². Aspects of embodiments of the present inventions disclosed in the present application are meant to address these issues.

Turning now to FIG. 13 there is shown an illustrative example of a laser component, e.g., an output coupler assembly 20 connected to an interconnecting element, e.g., used for vibration isolation, e.g., a bellows 22. The output coupler assembly 20 has an output coupler assembly plate 24, which consists of a vertical plate 24 that mounts and supports a front partially reflective optic 26, the output coupler, of the resonator cavity of the laser system which may be a single chamber system or an oscillator portion of a multi-chambered laser system, e.g., in a master oscillator, power amplifier (MOPA) configuration or may be the output of one or both of the laser chambers in a master oscillator power oscillator (“MOPO”) configuration. The assembly 20 consists of the optic 26 retained in an adjustable mount 30 and with a fixed aperture 40. The optic 26 may have, e.g., a 20% reflective surface facing the gas discharge chamber (not shown) and may form the front partial reflector of the resonator cavity of a laser oscillator section standing alone or in a multi-chambered configuration.

The OC assembly may include sealed adjustment screws 50, 52 for tip and tilt alignment of the optic 26, a beam seal flange 54 (shown in FIG. 6), to connect to the chamber bellows 60, and a bellows 70 to connect to the next optical module in the system, e.g., a wavemeter 62, in which there may be a beam splitter 64. V-clamps 68 (shown in FIG. 6) connect the OC to the mating modules. The optic 26 may be adjusted about the horizontal and vertical axes to facilitate beam pointing and laser alignment using the adjusters 52, 54. The beam limiting aperture 40 may be machined into a removable plate 70. The aperture cover 70 may be fastened to the assembly plate 24 by screws 72. The aperture cover 70 is centrally positioned in the nominal UV beam horizontal and vertical centerline positions, according to the horizontal and vertical alignments of the beam, recognizing that horizontal and vertical as used in this application refer to orientations as illustratively shown in the Figures and that orientations other than true horizontal and vertical, including switching horizontal as illustrated for true vertical and vice-versa may occur in actual practice.

### SUMMARY OF THE INVENTION

A high power gas discharge laser for and method of producing laser output light pulses of high energy density is disclosed which may comprise a laser output light pulse beam optical track having a plurality of modular components arranged in order from a laser light source to a laser system output port and defining a laser output light pulse beam path having a single centerline axis; a first optical module and a second optical module in series in the optical track; a flexible interface element intermediate the first and the second optical module and rigidly attached to each of the first and second optical modules; and an optical element having a fixed position in the output laser pulse beam path comprising a rigid attachment to the first optical module, and extending within the flexible interface element. The optical element may comprise a beam expander, which may comprise a lensed beam expander. The optical element may comprise at least a part of a telescoping lens set forming an optical beam expander and the at least a part of a telescoping lens set comprises the entire telescoping lens set forming the optical beam expander or the at least a part of a telescoping lens set may comprise a first part of the beam expander cooperating with at least a second part located in a subsequent optical module in the laser output pulse beam optical track along the same optical centerline axis. A plurality of aligning mechanisms may align the optical element to a first and a second axis of the laser output pulse beam, the first and second axes being generally orthogonal to each other and orthogonal to the optical centerline axis, and also along the optical centerline axis. The optical element may have as one component the output coupler optical element, which may be flat on one side and cylindrical convex on the other or cylindrical concave on the one side, facing the resonant cavity and cylindrical convex on the other side. The optical element may be variable, forming, e.g., a cylindrical “zooming” magnification optic which may be manually or electromechanically driven and therefore, capable of active control.

### BRIEF DESCRIPTION OF THE DRAWINGS

FIG. 1 shows schematically a beam expander optical layout according to aspects of an embodiment of the present invention;

FIG. 2 shows a graph of beam profiles before magnification at the output coupler plane according to aspects of an embodiment of the present invention;

FIG. 3 shows a graph of beam profiles after magnification at a beam expander output plane according to aspects of an embodiment of the present invention;

FIGS. 4A and 4B show graphs of data regarding a horizontal beam profile before magnification at a beam expander output plane according to aspects of an embodiment of the present invention;

FIG. 5 shows a graph of beam profile ratios and an energy density ratio according to aspects of an embodiment of the present invention;

FIG. 6 shows a side cross-sectional partially cut-away view of an optical component track according to aspects of an embodiment of the present invention;

FIG. 7 shows schematically an optical layout according to aspects of an embodiment of the present invention;

FIG. 8A shows a graph of the results of a sensitivity study; FIG. 8B shows a graph of the results of a sensitivity study;

FIGS. 9A and 9B show perspective views of a beam expander assembly according to aspects of an embodiment of the present invention from right and left side views respectively;

FIGS. 10A, 10B and 10C show respectively a perspective isometric view, a rear end view and a side view of a beam expander according to aspects of an embodiment of the present invention;

FIGS. 11a and 11B show a perspective and a side view, respectively, of a beam expander to output coupler junction, including in FIG. 11A a beam expander mounting plate interface according to aspects of an embodiment of the present invention;

FIG. 12 shows a perspective view of a complete field upgrade module and bellows inter-module vibration interconnection according to aspects of an embodiment of the present invention;

FIG. 13 shows a perspective isometric view of the prior art module replaced by the module of FIG. 12 according to aspects of an embodiment of the present invention;

FIGS. 14A and 14B show schematically aspects of an embodiment of the present invention;

FIG. 15 shows schematically aspects of an embodiment of the present invention;

FIG. 16 shows an OSLO ray trace illustrative of aspects of embodiments of the present invention.

### DETAILED DESCRIPTION OF PREFERRED EMBODIMENTS

Applicants have evaluated various possible options for addressing the above noted issues including the utilization of beam expansion to, e.g., reduce the laser output light pulse energy density from about 92 mJ/cm² to about 50 mJ/cm². applicants have determined that Maximum energy density scales closely with the beam magnification. Applicants have also determined that a 2×beam magnification (expansion) can deliver the reduced energy density desired, e.g., to about 50 mJ/cm². Various options present themselves to accomplish this result, however, applicants have determined that the optimum solution would involve as little change to existing components and interfaces as well as the interfaces and spacing of the various components, e.g., in the existing laser frames as well as the production of a field upgrade module that is most easily implemented in the field to also back-fit the aspects of embodiments of the present invention discussed in the present application. Applicants propose this 2×beam expansion occur in the horizontal plane, e.g., in present embodiments of applicants' assignee's laser systems the narrow dimension of the output laser light pulse beam. It will be understood that the terms horizontal and vertical and front and rear and the like as used in the present application are for the purpose of illustration only and conform to the illustrative views as shown in the figures, but that there orientations may not be the same in actual implementation, e.g., the beam could be rotated in certain applications to have the narrower dimension aligned in a vertical direction as vertical is illustrated in the drawings. An optimum choice is to accomplish such beam expansion by using the available volumes and spacing without moving modules or modifying the shutter module and/or moving out the shutter module bulkhead from its existing position in the laser frame. Also keeping the beam expander separate from the output coupler optic has been chosen as a currently implementable satisfactory embodiment.

Applicants therefore propose a solution implementing a beam expander utilizing, e.g., a telescoping lens set and, e.g., cylindrical lenses to limit the telescoping effect to the one axis, e.g., the horizontal axis of the laser output light pulse beam. Keeping the output coupler optic separate, i.e., not using a, e.g., 20% reflecting optic on the output of the resonator cavity as also the front lens (front meaning the first lens the output laser light pulse beam encounters in the optical train path) in the telescoping beam expander, removes, e.g., sensitivity of divergence to lens separation, sensitivity of beam pointing and divergence to OC beam steering and alignment, and profile distortion and higher than expected energy densities due to parasitic modes, along with more difficult OC and telescope alignment issues.

Applicants propose the use of anamorphic expansion, which can have an impact on existing components, e.g., the wavemeter, e.g., included as part of a wavelength stability module (“WSM”), e.g., due to profile dependencies, pointing dependencies, in the energy monitor, e.g., in regard to fluence dependencies in the power density meter, and profile and divergence issues with respect to the coarse wavelength circuit and component mountings and the like in the existing laser output light pulse optical train path, including the fine wavelength circuit, e.g., regarding degradation of beam homogenization and imaging the diffractive diffuser pattern. An advantage of expansion with lenses over prism expanders is the lack of a variation in the centerline of the optical path.

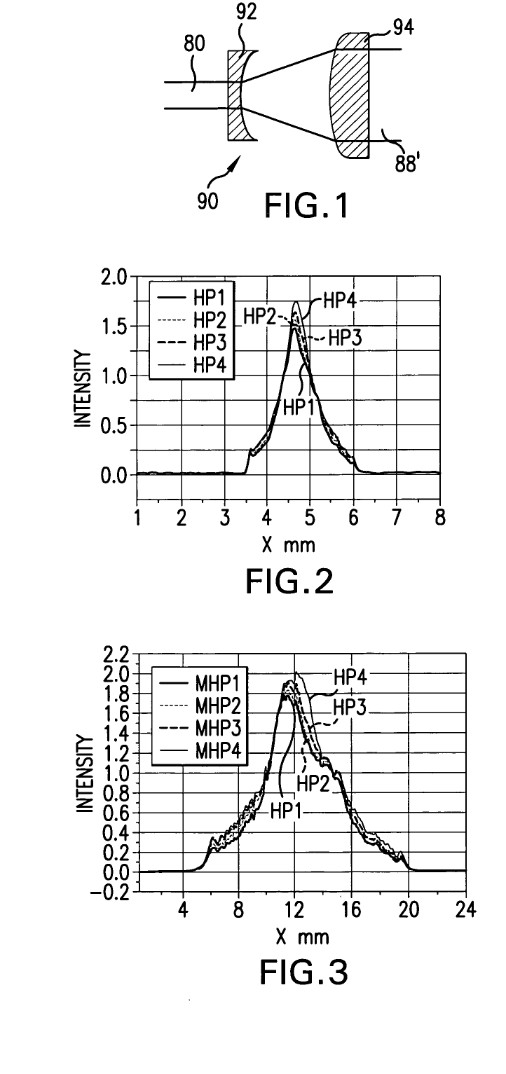

Turning now to FIG. 1 there is shown schematically a top view of an exemplary beam expander 90 optical layout. The beam expander 90 may comprise a front cylindrical concave lens 92 and a rear cylindrical convex lens 94 and the laser output light beam 80 may be passed through the beam expander 90 to expand the beam 80 in the horizontal axis, vertically in the illustration of FIG. 1, to form an expanded beam 80′, e.g., expanded by 2×, e.g., if the do for the lens 92 is 2.4 mm and the d₁ for the lens 94 is 6 mm and the separation a between the optical centers of the lenses is 49 mm (air space=about 36.7 mm), then an expansion of about 2.5 in the horizontal axis, i.e., in the vertical as illustrated in FIG. 1, can be achieved. This or other embodiments discussed in this application can enable, according to aspects of an embodiment of the present invention, the utilization of existing volumes and spacing for the location of the beam expander and, in the case of certain aspects of embodiments of the present invention, at the same time keep the output coupler separate. According to other aspects of embodiments of the present invention it is contemplated to have all of the beam expander on one side or the other of the wavemeter beam splitter, e.g., on the upstream laser light pulse beam path from the wavemeter and without modification to the shutter module or alternatively to straddle the wavemeter, or even insert the beam expander between the wavemeter and a pulse stretcher. all as more fully described below.

Turning now to FIGS. 2 and 3 there are shown, respectively, beam horizontal profiles before magnification at the output coupler 26 plane, i.e., at the input plane to lens 92, and beam horizontal profiles after magnification at beam expander 90 output plane, i.e., the output plane of the lens 94. The basic beam shape stays similar to the original beam. Minor changes can be seen, e.g., in the beam symmetry, however, beam symmetry ordinarily is not at issue for beam specifications at this point in time for certain applications utilizing gas discharge laser output light pulse beams. FIGS. 2 and 3 show various horizontal profiles (“HPs”) HP1-HP4 and their respective magnifications.

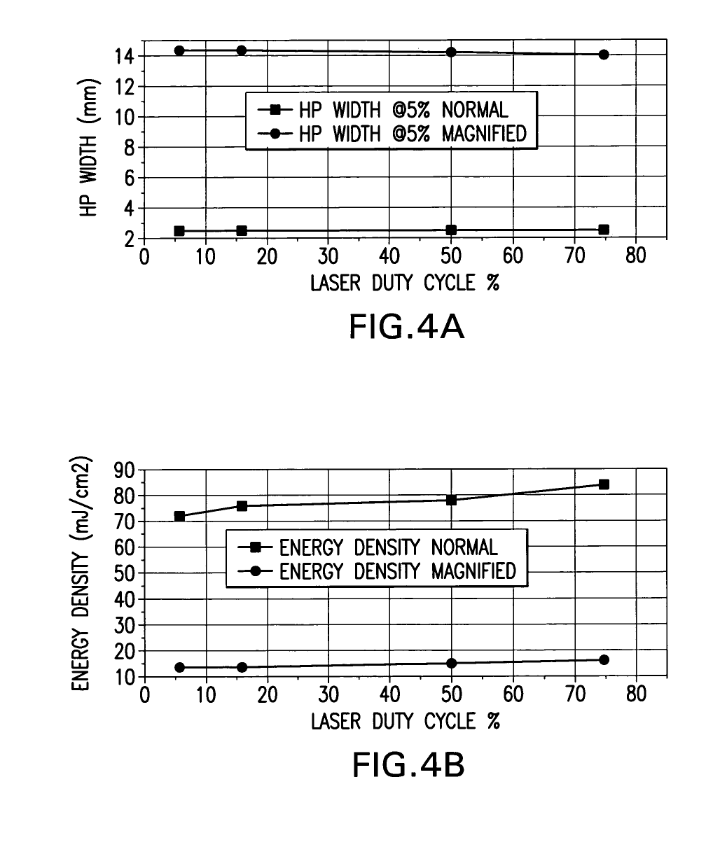

Turning now to FIGS. 4A and 4B there are shown beam profiles before magnification and after magnification, e.g., at the beam expander 90 output plane. FIG. 4A shows the horizontal profiles for beams at various laser duty cycles from 5% to 100% at full width at 5% for either normal or magnified over a range of duty cycles. FIG. 4B shows the energy densities for the normal and magnified beams over the range of duty cycles.

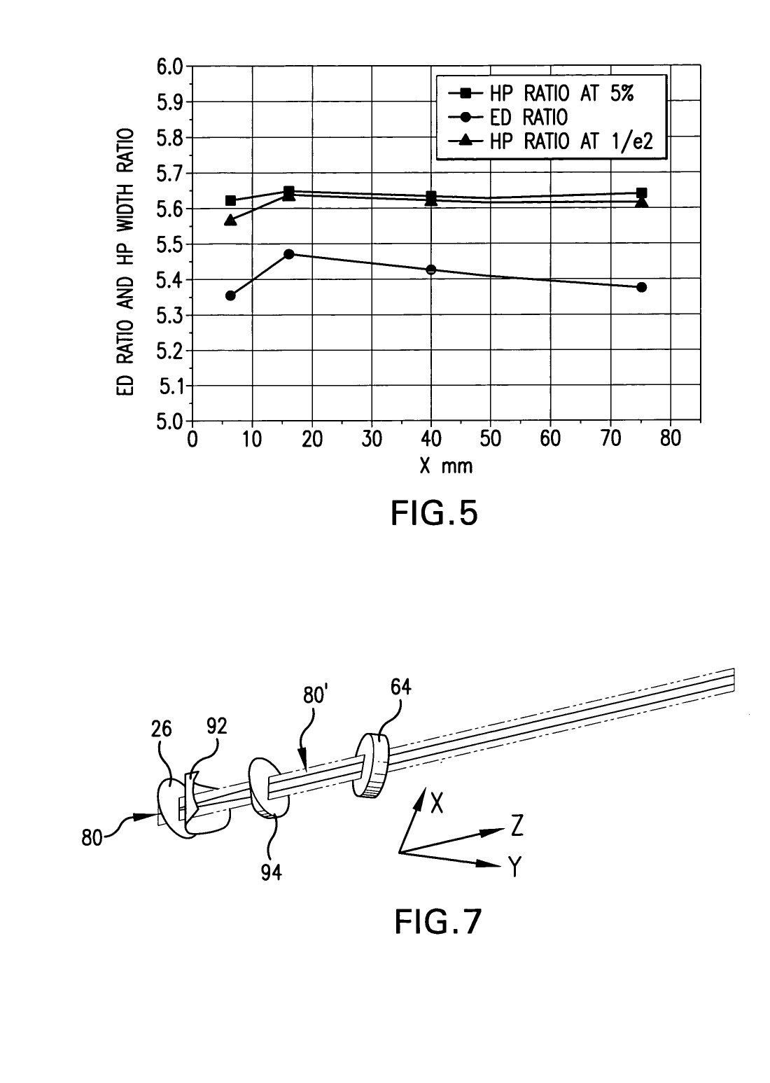

Turning now to FIG. 5 there is shown beam profile ratios at 5% and 1/e² and an energy density ratio for the horizontal profiles at the respective duty cycles. The horizontal pulse width at 5% and 1/e² scale very closely with each other. Energy density also follows the general trend. The small difference in the energy density ratio to horizontal profile ratio could be due to vertical profile variations and also the fact that the data records only the energy density peak. The above values give estimates for energy density @2× magnification of 35.835, 37.67, 38.995 and 41.61, respectively, for the plotted 5%, 16%, 50% and 75% duty cycle points and estimated horizontal profile at full width 5% for the same points of 5.08, 5.04, 5.02 and 4.96 for 2× magnification. The measurements of this data were done on a table top, outside the laser system, and with CaF₂ transmitting an attenuated beam because only part of the beam was picked-off and measured, leaving thermal or other effects on the beam expander 90 out of these measurements. The charts demonstrate that at about a 2× magnification the goal of achieving a reduction of energy density down to about 50 mJ/cm² is possible.

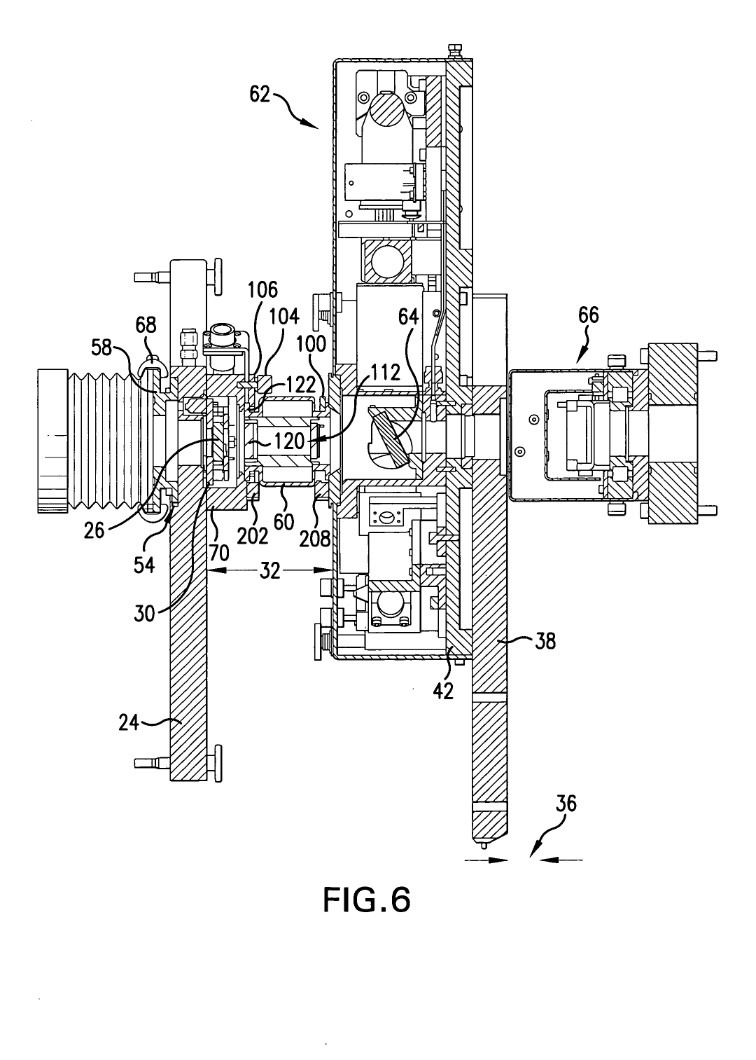

Turning now to FIG. 6 there is shown a partially cross-sectional and partially cut away side view of an optical module track layout along an optical path according to aspects of an embodiment of the present invention, which illustrates various options, including using the available spacing 32 and volume between an output coupler, comprising an output coupler assembly 20 mounting plate 24 and an output coupler cover 70 enclosing an output coupler optic 26, and a wavemeter 62, without, e.g., moving modules or modifying, e.g., the shutter module 66 or its mounting bulkhead 38. Another option could be to move the bulkhead 38 to the right by a distance 36, e.g., several cm and to mount the shutter 66 directly onto the back plate 42 of the wavemeter 62. Another option could be to straddle the beam splitter 64 of the wavemeter 62 with the optics forming the beam expander 90, with either of the above noted two options for spacing.

Turning now to FIG. 7 there is shown optical layout for a beam expander according to aspects of an embodiment of the present invention. For an R₁ for lens 92 of −12.7 mm and an R₂ for lens 94 of 30.5 mm and a separation of 37.8 mm, a magnification of 2.4 can be achieved and for an R₁ for lens 92 of −16 mm and an R₂ for lens 94 of 32 mm and a separation of 34 mm, a magnification of 2 is possible.

Using an R₁ of −30.5 for lens 92 and an R₂ of 76.3 for lens 94 with a separation of 97.8 mm only a modest increase in magnification to 2.5 is achieved.

TABLE I

| | | P-V OPD (# | RMS OPD (# | Spot Size GEO | Spot Size GEO |
|---|---|---|---|---|---|
| | System configurations | of waves) | of waves) | RMS YA (mRad) | RMS XA (mRad) |
| Design 1 | Telescope with collimated | 0.312 | 0.109 | 0.049 | |
| | source (Ideal system) | | | | |
| | Telescope + WM BS | 0.312 | 0.109 | 0.085 | 0.049 |
| | Telescope + WM BS + | 20.037 | 5.869 | 0.457 | 0.886 |
| | divergence | | | | |
| | Telescope + WM BS + | 22.265 | 5.922 | 0.523 | 0.990 |
| | divergence + mechanical | | | | |
| | tolerance stacking up − | | | | |
| | worse case | | | | |
| Design 2 | Telescope + WM BS + | 21.600 | 5.894 | 0.351 | 0.985 |
| | divergence + mechanical | | | | |
| | tolerance stacking up − | | | | |
| | worse case | | | | |

TABLE II

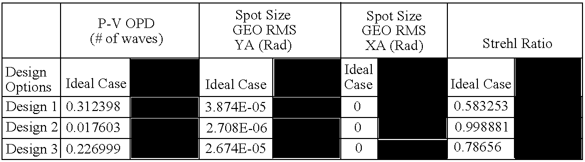

Tables I and II are illustrative of optical properties of various possible configurations. for the above describes possible designs, the first can provide for minimal optical changes to the existing design at the expense of some optical performance and higher sensitivity to mechanical/alignment issues, with also some position adjustments needed. The latter can have lower sensitivity to mechanical/alignment issues and provide for a straight drop in field replacement, without position change requirements and also good optical performance.

Turning now to FIG. 19 there is shown an OSLO ray trace model according to key optical parameters illustrative of aspects of an embodiment of the present invention, utilizing the parameters of wavelength at 248.35 nm, lens material for the lenses 92, 94 being CaF₂, aperture size 2.5 mm×15 mm, and including total rays traced equal to 872, and total rays traced through the aperture, equal to 2.77% (24) and model input parameters of centering error along the y axis, rotational error on a single component along the x axis, and rotational error between two elements along the z axis, and separation error, and with the model output parameters, comprising peak-to-valley optical path length difference (“P-V OPD”), in number of waves, i.e., wavefront peak-to-valley error, in number of waves, and geometric spot size RMS, the standard deviation of the spot size distribution in radians among traced rays, in the x and y axes, a measure of the divergence, and the Strehl ratio, and a measure of closeness to an aberration free system.

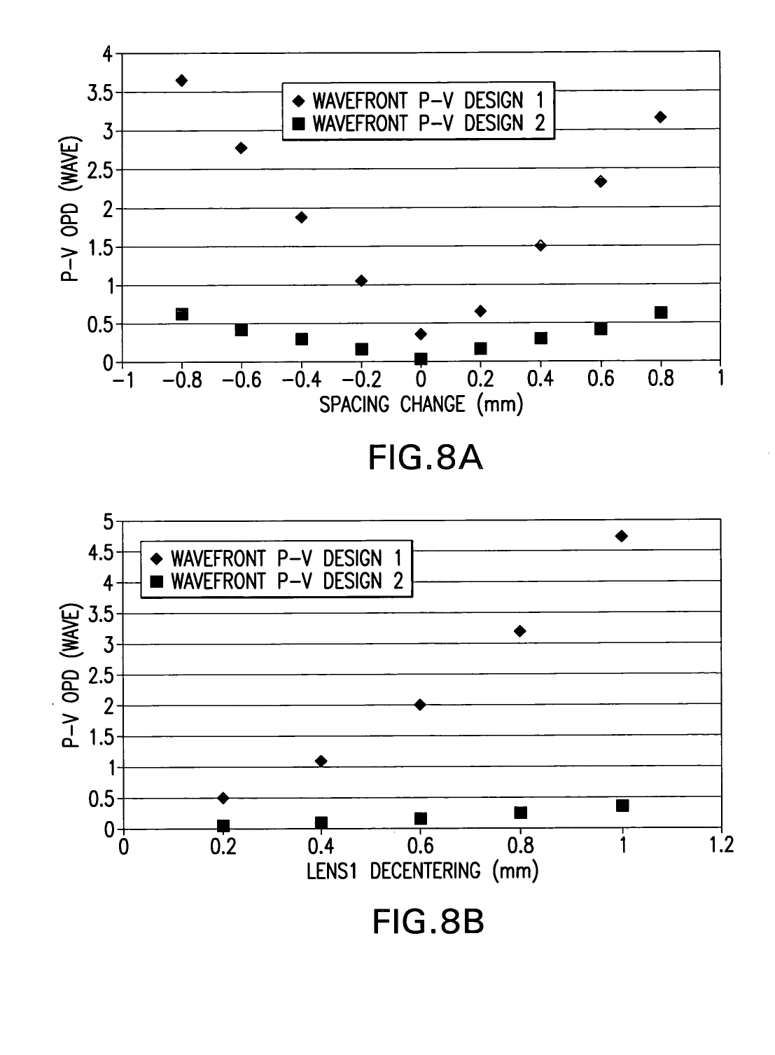

Turning now to FIGS. 8A and 8B there are shown the results of sensitivity studies performed by applicants, with, e.g., the design optimized to an ideal case first and then followed by the inducement of, e.g., a perturbation to one of the input parameters, e.g., at a constant interval. Also illustrated is the symmetry of the sensitivity plots for output vs input for various cases.

Applicants have determined that a design with the beam expanding telescopic lenses between the output coupler and the wavemeter and with an R₁ of −12.7 mm and an R₂ of 25.4 mm and a separation of 27 mm, resulting in a magnification of 2.0, the optics of the beam expander 90 are less sensitive to, e.g., mechanical errors in general. Using a less powerful lens and longer separation, e.g., by straddling the beam splitter in the wavemeter, could gives a better optical performance in certain respects, but with the disadvantages of straddling the beam splitter. With respect to peak to valley optical path length difference (“P-V OPD”) (# of waves) and geometric spot size of the RMS in the Y axis in radians, and the Strehl ratio, the front lens decentering, x rotation and front and rear lens z rotation exhibit a moderate sensitivity. Similarly, each of these output parameters exhibit minimal sensitivity for rear lens decentering and rear lens x axis rotation, and strong sensitivity to separation, and to incoming divergence, whereas for the geometric spot size RMS in the x axis in radians, this output is generally insensitive to any of these inputs except for a moderate sensitivity to front and rear lens z axis rotation and a strong sensitivity to incoming divergence.

It is, therefore, apparent that system performance according to aspects of an embodiment of the present invention is dominated by the incoming divergence. The worse case scenario mechanical tolerance stack up has little effect on system performance in terms of wavefront properties and divergence. No position adjustment, or acceptably minimal position adjustment, is needed, therefore, for mechanical mounting of the beam expander assembly body 110.

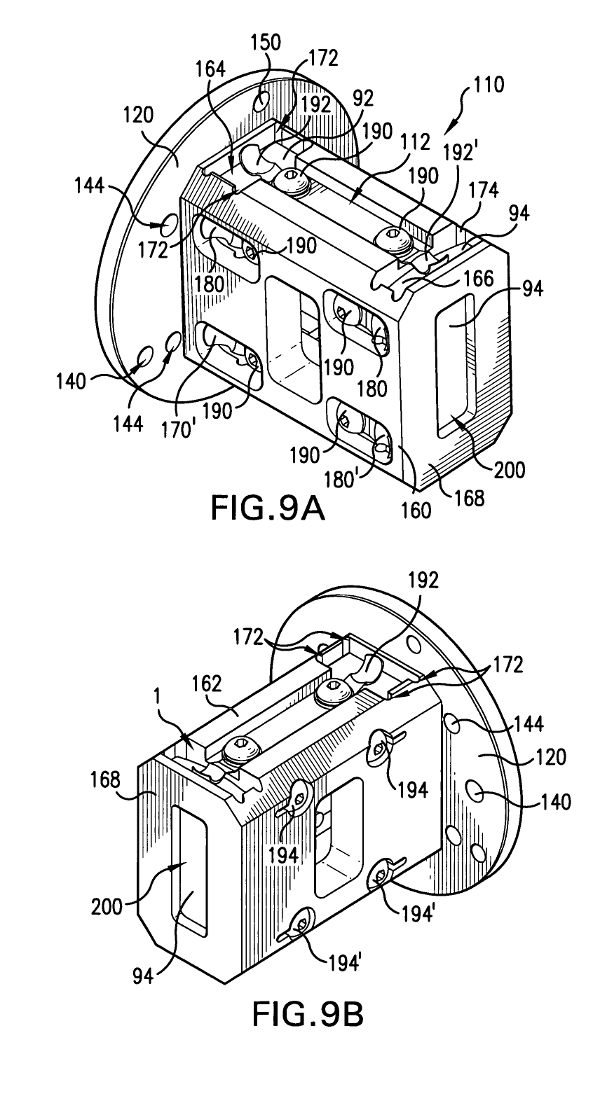

Turning now to FIGS. 9A and 9B there are shown perspective isotropic views of a beam expander assembly 110 according to aspects of an embodiment of the present invention from right and left side views. The beam expander assembly 110 may comprise, e.g., a beam expander assembly body 112, which may be machined along with or otherwise attached, e.g., by welding, to a generally cylindrical mounting plate 120. The cylindrical mounting plate 120 may be attached to a front bellows mounting plate 106, e.g., by mounting screws 152, e.g., within the confines of an annular mounting flange ring 122 on the bellows 60.

The beam expander housing assembly 110 may also be formed to comprise a beam expander assembly body side wall 160, a beam expander assembly body top wall 162, and a beam expander assembly body rear wall 168. The beam expander assembly 110 may have formed in it a front optical element indexed and wedged receiving slot 164, e.g., not perpendicular to the beam propagation direction, e.g., oriented at a 0.5° vertical angle to reduce direct back reflections of the beam into the resonator cavity, and a rear optical element indexed and wedged in receiving slot 166.

The optic forming the front lens 92, i.e., where the beam enters the beam expander 90, may be wedged into the slot 164 with relatively tight tolerance as will be understood by those skilled in the art, for positioning the front optical element axially along the optical path and also for the prevention of x and y axis rotation. similarly the optic forming the rear lens 94 may also be indexed/retained relatively tightly in the receiving slot 166 in the beam expander assembly body 112. Spring clips 192, 192′ hold the respective lens 92, 94 vertically and 170, 170′ and 180, 180′ respectively, hold the optics forming lens 92 and 94 against horizontal movement in the Y axis and spring clips (not shown) hold the respective optics 92, 94 against movement in the z axis. The spring clips 170, 170′, 180, 180′ and 192, 192′ are tightened by tightening screws 190. The top spring clamps (not shown) and bottom spring clamps (not shown) holding the optics 92, 94 against z axis movement, are tightened in place by tightening screws 194 and 194′ respectively. These combinations of elements may serve to index the position of the front and rear optics 92, 94. The optic receiving slots 164, 166 may have a plurality of vertically extending gripping slots, for gripping the optics 92, 94, e.g., with tweezers or other tool, in inserting or removing the optic 92, 94 from the respective slot 164, 166. The optics 92, 94 may have indexed plano-surfaces facing, respectively, the front and rear of the beam expander assembly body 112, which are indexed by the alignment pins 210 aligning the assembly body 112.

The beam expander assembly body 112 may also have an aperture 200 formed in the rear wall 166, which is generally of the size of the expanded beam, e.g., about 5 mm×15 mm. An aperture 124 in the cylindrical mounting plate 120 may be generally of the size of the beam entering the front optic 92, e.g., 2.5 mm×15 mm.

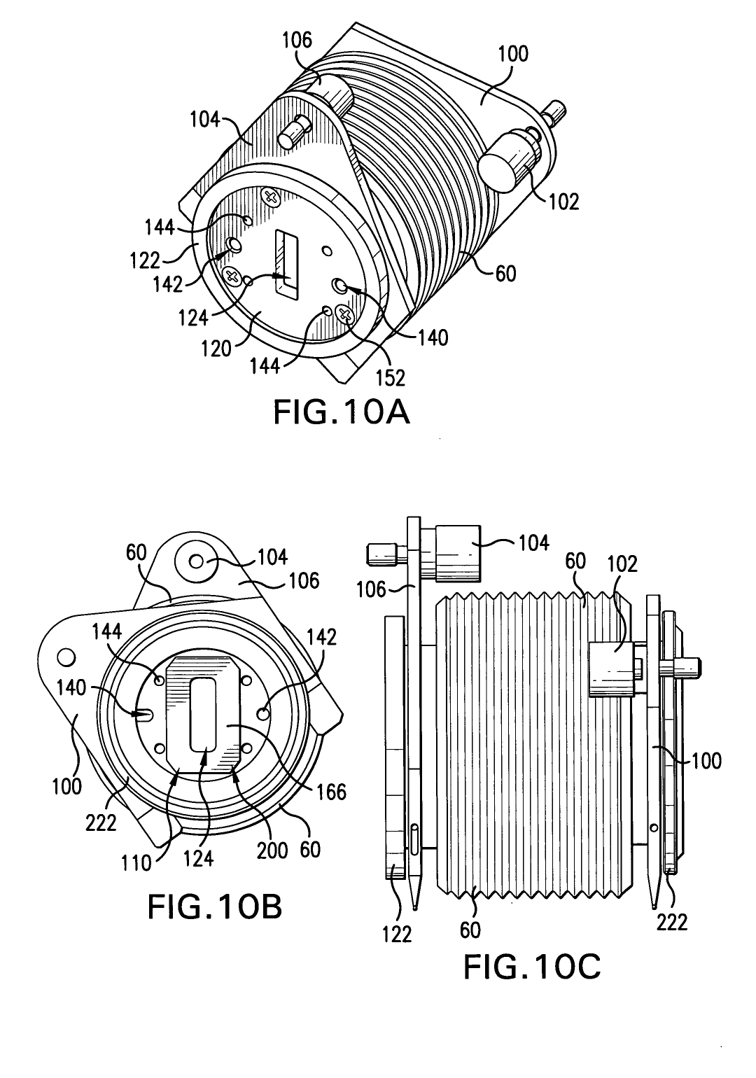

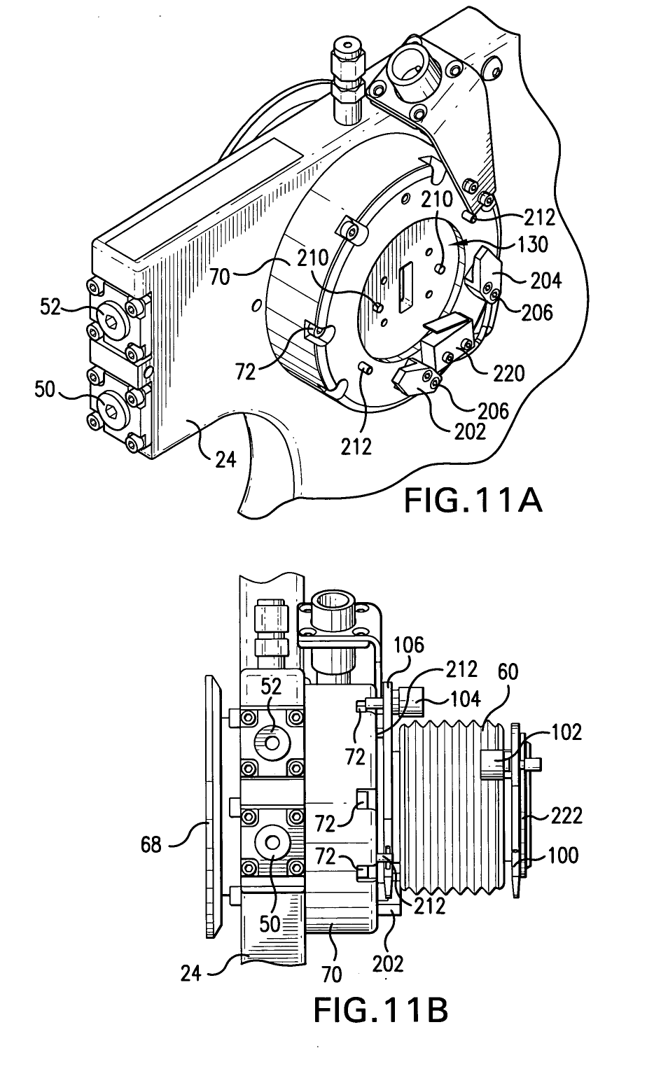

The bellows 60 (which is shown in most views for simplicity without its spiraling coils, may also be attached to the wavemeter at the wavemeter end of the bellows 60 by a bellows wavemeter end mounting plate 100, which may have a slot (not shown) to engage a bellows mounting flange 222 as shown, e.g., in FIG. 10C. The bellows wavemeter end mounting plate 100 may, in turn, be attached to the housing of the wavemeter 62 by an attachment screw 102 and the bellows optical coupler end mounting plate 106 may be used to attached to the bellows 60 by its annular flange ring 122, shown in FIG. 10A and with the mounting plate 106 having a slot (not shown) that engages the flange 122. The mounting plate 106 may be, in turn, attached to the output coupler plate 24 by an attachment screw 104 and bellows mounting brackets 202 and 204 on the bellows cover 70, shown in FIG. 11A may also engage the bellows front mounting plate 106 in securing the bellows 60 to the output coupler cover 70 and may be attached to the cover 70 by mounting screws 206. A bellows mounting bracket 208 may similarly be attached to the housing of the wavemeter 62, as shown in FIG. 6.

As shown in FIG. 10A, the cylindrical mounting plate 120 may have formed in it a pair of beam expander alignment pin 210 receiving cavities 140, 142 each having a beveled leading edge for ease of receiving alignment pins 210, shown in FIG. 11A, protruding out from the facing surface of a cylindrical recess 130 in the output coupler cover 70. The alignment pin receiving cavity 140 may be elongated horizontally to allow for tolerance variations, e.g., in horizontal alignment adjustment. Purge gas portals 144 on both the cylindrical mounting plate 120 and the cover 70 may be used to allow purge gas flow between modules. Suitable purge gas sealing elements (not shown) may also be incorporated into the design as appropriate.

Mounting screws 152 inserted through mounting screw openings 150 in the beam expander optics mounting plate 120 may also serve to align and also to attach the cylindrical mounting plate 120 to the bellows mounting plate 106.

A pair of front bellows mounting plate alignment pins 212 may serve to align the bellows mounting plate 106 to the cover 70. A bellows tube interlock limit switch 220 may serve to indicate to presence or absence of an installed beam bellows, e.g., to a purge control system (not shown). mechanical errors and provides optical performance that is very acceptable. Divergence in other possible designs can, e.g., smear out some of the divergence improvement by a 2×horizontal beam expansion according to aspects of an embodiment of the present invention, which exhibits relatively little effect from divergence. That is to say, an advantage of aspects of embodiments of the present invention includes the fact that the telescoping lens set does not have any effect (or has a very minimal effect) on the divergence of the beam, even while magnifying it. according to aspects of embodiments of the present invention there is no added (or very little added) divergence to the already relatively large intrinsic divergence of gas discharge laser output beams in general.

According to aspects of an embodiment of the present invention with a 2×beam expansion design, performance improvement by fine tuning R₁ and R₂ for the given usable space of about 50 mm between existing modules without having to move, e.g., the shutter bulkhead is of minimal impact. Also according to aspects of an embodiment of the present invention for, e.g., the 2× magnification changing the optical design from that described in the present application has little impact on improving significantly the optical performance. Thus the monolithic design can minimize mechanical tolerance stack up and also eliminate the need for any position adjustment on the beam expander assembly body 110, with adjustments in the optics within the assembly body 110 prior to installation of the body assembly 110 being sufficient.

In operation according to aspects of an embodiment of the present invention the bellows 60 interface mechanism to the output coupler cover 79 remains essentially the same as in the prior art output coupler plate design and facilitates a simple field upgrade kit with essentially the same output coupler cover 70 to bellows 60 interface and the beam expander as part of the output coupler plate 24 and bellows 60 assembly as it exists in the prior art assembly, and also with no change to the bellows 60 to wavemeter 62 interface design as it also exists in the prior art. The bellows continues to perform its normal function without interference from the nested beam expander 90, and essentially no additional space is needed between the output coupler plate 24 and the wavemeter 62 for the insertion of both the beam expander 90 and the bellows 60.

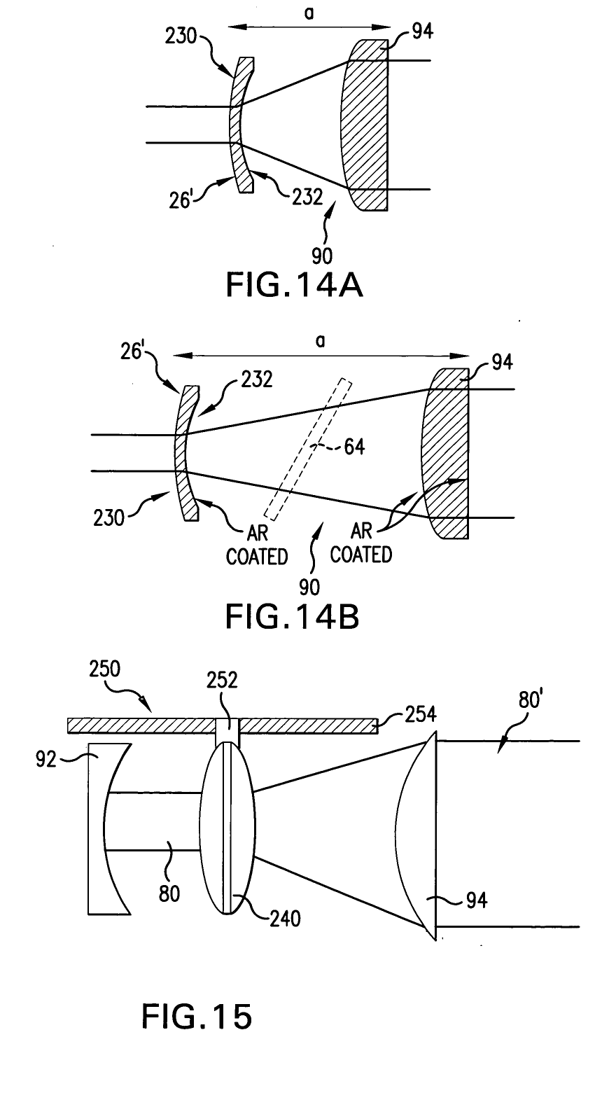

Turning now to FIGS. 14A and 14B there is shown schematically aspects of an embodiment of the present invention including, e.g., a utilization of an existing optical element in the system at the output coupler side of the bellows 60, e.g., the output coupler 26′ itself, having on one face a partially reflecting mirror 230 and on the other side a cylindrical concave lens 232. As shown in FIG. 14A, the optic 94 may be positioned as shown in the above illustrated embodiments, with the added separation a between the output coupler optic position as illustrated in the above discussed embodiments and the position of optic 92 in the beam expander assembly body 112 allowing for more beam expansion in the short axis of the beam.

As shown in FIG. 14B, an embodiment can be made that eliminates the beam expander assembly body as described in regard to above discussed embodiments and has the beam expander 90 straddle the beam splitter 64 in the wavemeter for an even longer separation a. In the embodiment of FIG. 14D the rear optic 94 may be placed in a module or element downstream in the beam path from the wavemeter, e.g., in a similar assembly body to assembly body 112 only placed in a bellows, e.g., between the wavemeter 62 and bulkhead 38 or between the shutter 66 and bulkhead 38.

Turning now to FIG. 15 there is shown schematically a top view of aspects of an embodiment of the present invention in which the beam expansion may be made variable and even actively controlled. The beam expander 90′ may comprise a front lens 92, or alternatively 230, and a rear lens 94, with an adjustable intermediate cylindrical lens 240. Also shown schematically is an intermediate lens transport mechanism 250 which is adapted to longitudinally translate the position of the lens 240 to vary the overall magnification. Such a mechanism may be utilized with above described embodiments of beam expander assembly bodies 112 for a variable beam expander 90, perhaps with the need to move a bulkhead to enable, e.g., a longer bellows 60 to accommodate enough of a longitudinal movement of the moveable intermediate lens 240 for an effective range of magnifications.

An illustrative and simplified schematic for a translation system 250 may include, e.g., a lens mounting bracket 252 threadedly engaging a worm gear 254. The translation mechanism may be controlled by a controller (not shown), e.g., in a feedback control loop, using, e.g., a beam profile monitor at a location within a lithography tool for which the laser system is a light source, e.g., to control the energy density of the dose of exposure light provided through a mask to an integrated circuit wafer for resist exposure during an integrated circuit fabrication step. The moveable lens 240 may, therefore, be positioned in a desired location and not thereafter adjusted during normal operation of the laser system or some time period of normal operation of the laser system, e.g., during the fabrication of a particular batch of wafers. Also shown in FIG. 15 is a second lens transport mechanism 260, which may comprise a bracket 262, attached to the lens 94 and threadedly engaging a threaded rod 264, for movement of the lens 94 similarly to the movement of the lens 240. The threaded rods 250, 264 may be separately driven or geared together, e.g., for movement of both lens 94 and lens 240 at the same time in the same or different directions and the gearing and/or the thread pitch may be adjusted to move the lenses 94 and 240 different distances, e.g., for the dame amount of turns of a rotary stepper motor or the like.

Turning now to FIGS. 16-18 there is shown schematically and by way of illustration only additional variable magnification lens arrangements, 280 and 290, either of which may be manipulated for translational motion, e.g., in the same direction, by a translation sleeve, that may, e.g., fit over the mounting 112 and inside the bellows 60. For example, there may be in addition to the front lens 92′, which in the embodiments of FIGS. 17 and 18 may be a diverging lens, an additional diverging lens 282 in the embodiment of FIG. 17 or a converging lens 292, each of which may be translated in the optical axis of the lens arrangement, and also a converging lens 284 in the embodiment of FIG. 17 and an additional diverging lens 294 in the embodiment of FIG. 18, each of which may also be translatable in the optical axis of the arrangement 280, 290. These lenses may be translated by the sleeve 272, e.g., by having a long translation slot 274 in which may slide a translation guide pin 278 linked to the lens 282, 292, and a short translation slot 276 in which may slide a translation guide pin 278 connected to the lens 284, 294, such that when the sleeve is rotated in the direction of the top of the paper in FIG. 16, the lens 282, 292 moves a distance of x and the lens 284, 294 moves a distance of y. It will be understood that the slots 274,276 may have different directions as well as different slopes so that the lenses 282, 292 travel in a different direction than the lenses 284, 294 if desirable. It will be understood by those skilled in the art that according to the type of lens arrangement used, e.g., either of the arrangements of FIGS. 17 and 18 the parameters of the lenses and the desired beam effects to be attained for the beam exiting the beam expander, the relative distances of movement, the relative starting and ending points in relation to the fixed mirror 92′ and relative directions of movement, etc., may be determined from the laws of physics relating to such optical trains as depicted and others that may also be employed for this functionality.

The moveable lens(es) may thereafter be reset to another location for a different batch of wafers, e.g., to accommodate different desired parameters of the light delivered at the wafer. Alternatively, the moveable mirror may be actively controlled, e.g., to have different positions for different pulses within a burst of pulses during burst mode operation of the laser system, based upon feedback control responding to changes in laser light parameter requirements at the wafer during such a burst. It will be understood that as used in the present application this distinction is between one of the moveable lens being not actively controlled during normal operation of the laser system and being actively controlled during normal operation of the laser, i.e., one being controlled relatively infrequently, if at all, and in response to relatively infrequent parameter change necessities, e.g., from batch to batch in the manufacturing process, and one being changed relatively rapidly, essentially in real time, in response to relatively rapid parameter change necessities, e.g., for different pulses in a burst, and including pre-programmed changes, which may also be feedback controlled, but, e.g., changing from burst to burst, and directing preselected desired moveable mirror positions during a given burst.

Turning now to FIGS. 16-18 there is shown aspects of an embodiment of the present invention employing a translation sleeve 270 to move two lenses within the beam expander. The translation sleeve may fit around the beam expander assembly body 112, and accommodation may be made for the translation of lenses, e.g., lenses 282 and 284 shown in FIG. 17 and 292, 294 shown in FIG. 18. The translation sleeve 270 may have formed in its wall a long translation guide groove 274 and a short translation guide groove 276, each of which has an angle of attach with respect to the longitudinal axis of the sleeve 270, such that, e.g., the lens 282, 292 will move a greater distance than the lens 284, 294 when the sleeve 270 is rotated. A guide pin 278 may be attached to the lens 282, 292 and a guide pin 278 may also be attached to the lens 284, 294, each respectively for sliding engagement in the respective slot 274, 276 for translation of the respective lenses 282, 292 and 284, 294 when the sleeve is rotated. In this manner it will be understood by those skilled in the art of such mountings, e.g., as may be used in cameras and the like, the beam expansion may be increased or decreased, while maintaining collimated and correctly pointed output light from the beam expander 90 using various lens arrangements, e.g., lens arrangement 280, with the lens 282 being diverging and the lens 284 being converging, or the lens arrangement 290 with converging lens 292 and converging lens 294.

It will be understood by those skilled in the art that aspects of embodiments of the present invention result in improvements over the prior art, e.g., in increasing the stability of beam pointing and direction and alignment, and also in decreasing the sensitivity of the laser output light parameters to misalignment and thermal variations and the like, as compared, e.g., to laser output light pulse beam expanders using, e.g., beam expanding prisms.

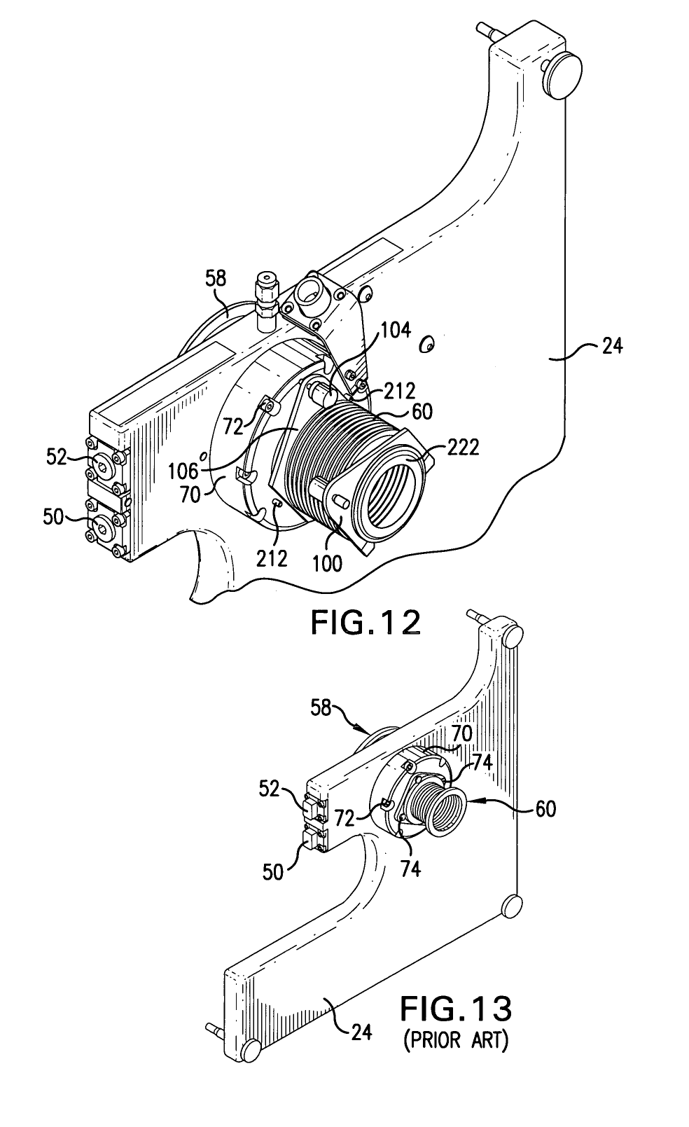

It will be understood by those skilled in the art that the above description of aspects of embodiments of the present invention are meant to be illustrative only and the present invention should be considered to be defined only by the scope of the appended claims and not limited to the aspects of embodiments disclosed in the present application. Many changes and modifications could be made to aspects of embodiments disclosed in the present application and still remain within the scope of the amended claims. For example, aspects of embodiments of the present invention could be implemented as shown in the illustrative aspects of the present invention with all of the beam expander optics mounted between the presently existing output coupler and wavemeter in certain of applicants assignee's laser products, i.e., without repositioning any of the existing components in the laser system output optical train path. Such an embodiment necessitates modifications to existing components only to the extent of the changes illustrated above to the external optics (output coupler) assembly, e.g., to accommodate mating with and alignment with the beam expander assembly housing body and the interface with the wavemeter end of the bellows and thus also the wavelength stabilization module (“WSM”) interface. In addition, however, aspects of embodiments of the present invention could be implemented with the beam expander optics between the output coupler cover and the bellows, with consequent modifications to optical paths and surrounding components or with the front end lens in, e.g., a beam expander assembly housing as illustrated above and the real lens on the opposite side of the wavemeter beam splitter, e.g., as an output window to the wavemeter or intermediate the wavemeter and the shutter, with another set of consequent changes. These latter two options at the current time are believed less attractive by applicants due to the necessity for the changes noted in the present application as well as changes to the WSM mounting bulkhead and the shutter assembly. In addition, the utilization of a single field upgrade swap out change package, e.g., as illustrated in FIG. 12 is not possible with such additional changes. However, such designs can have satisfactory utility for other reasons. Further, a design could be utilized in which the output coupler optic can be replaced with the front lens of the beam expander with additional considerations and modifications then required as noted in the present application. Such an implementation could be utilized with aspects of embodiments discussed above dependant on positioning of the lenses and other component modifications.

In addition, the above aspects of embodiments of the present invention have been described in relation to expansion of the beam in one axis only. However, applications may present themselves where it is desirable to expand the beam in both axes in which event, e.g., added cylindrical lenses for such expansion may be employed. It will also be understood that rigidly mounted as used in the present application is meant to mean rigidly in the sense of any optical device or instrument in which optical elements are held in place, e.g., by slot tolerances and spring clips and like spring retaining devices, so that the optic in normal use is likely not to move, but the optic for many reasons is not intended to be so rigidly mounted or retained as to never, e.g., be removable for cleaning, repair or replacement. Other elements describes as rigidly attached, also are so attached during normal operation, or at least designed to be, but are not so rigidly attached as not to be removable and in fact are often designed to be removable for maintenance and repair reasons. Flexible as used in the present application will also be understood to mean, e.g., in the case of a bellows, the type of flexibility exhibited by the respective flexible element, e.g., a bellows being relatively more flexible in the longitudinal axis as the bellows expands and contracts, but also allowing through such expansion and contraction for some flexibility in axes, e.g., orthogonal to the longitudinal axis. It will also be understood by those skilled in the art that a fixed position in the optical path, as used in the present application is intended to mean fixed to the degree attainable by the tolerances of manufacturing of elements, including mounting and retaining elements such that the element is in a position that is determinable within some expected tolerances and remains relatively in the same position during proper operation and within the given tolerances. Extending within an element as used in the present application is intended to mean, as will be similarly understood, to occupy at least some available open volume within another element. It will also be understood that lensed as used in the present application means having at least one lens and expanding the beam while retaining a single optical centerline axis for the beam within the beam expander itself. Also, as used in the present application, telescoping lens set is intended to mean a lens set of any number of lenses that adds magnification to the beam and thus expands the beam size in at least one axis of the beam orthogonal to the optical path of the beam. It will also be understood by those skilled in the art that expanding the beam spatially or geometrically is intended to mean changing the shape and/or size of the beam in one or more axes and expanding the beam temporally is meant to indicate extending the duration of the effective portion of the pulses in the beam, e.g., to increase T_{IS} as is well known in the art.

1. A high power gas discharge laser producing laser output light pulses of high energy density comprising:
a laser output light pulse beam optical track having a plurality of modular components arranged in order from a laser light source to a laser system output port and defining a laser output light pulse beam path having a single centerline axis;
a first optical module and a second optical module in series in the optical track;
a flexible interface element intermediate the first and the second optical module and rigidly attached to each of the first and second optical modules; and
an optical element having a fixed position in the output laser pulse beam path comprising a rigid attachment to the first optical module, and extending within the flexible interface element.

2. The apparatus of claim 1 further comprising:
the optical element comprises a beam expander.

3. The apparatus of claim 1 further comprising:
the optical element comprises a lensed beam expander.

4. The apparatus of claim 2 further comprising:
the optical element comprises a lensed beam expander.

5. The apparatus of claim 1 further comprising:
the optical element comprises at least a part of a telescoping lens set forming an optical beam expander.

6. The apparatus of claim 2 further comprising:
the optical element comprises at least a part of a telescoping lens set forming an optical beam expander.

7. The apparatus of claim 3 further comprising:
the optical element comprises at least a part of a telescoping lens set forming an optical beam expander.

8. The apparatus of claim 4 further comprising:
the optical element comprises at least a part of a telescoping lens set forming an optical beam expander.

9. The apparatus of claim 5 further comprising:
the at least a part of a telescoping lens set comprises the entire telescoping lens set forming the optical beam expander.

10. The apparatus of claim 6 further comprising:
the at least a part of a telescoping lens set comprises the entire telescoping lens set forming the optical beam expander.

11. The apparatus of claim 7 further comprising:
the at least a part of a telescoping lens set comprises the entire telescoping lens set forming the optical beam expander.

12. The apparatus of claim 8 further comprising:
the at least a part of a telescoping lens set comprises the entire telescoping lens set forming the optical beam expander.

13. The apparatus of claim 5 further comprising:
the at least a part of a telescoping lens set comprises a first part of the beam expander cooperating with at least a second part located in a subsequent optical module in the laser output pulse beam optical track along the same optical centerline axis.

14. The apparatus of claim 6 further comprising:
the at least a part of a telescoping lens set comprises a first part of the beam expander cooperating with at least a second part located in a subsequent optical module in the laser output pulse beam optical track along the same optical centerline axis.

15. The apparatus of claim 7 further comprising:
the at least a part of a telescoping lens set comprises a first part of the beam expander cooperating with at least a second part located in a subsequent optical module in the laser output pulse beam optical track along the same optical centerline axis.

16. The apparatus of claim 8 further comprising:
the at least a part of a telescoping lens set comprises a first part of the beam expander cooperating with at least a second part located in a subsequent optical module in the laser output pulse beam optical track along the same optical centerline axis.

17. The apparatus of claim 9 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

18. The apparatus of claim 10 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

19. The apparatus of claim 11 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

20. The apparatus of claim 12 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

21. The apparatus of claim 13 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

22. The apparatus of claim 14 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

23. The apparatus of claim 15 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

24. The apparatus of claim 16 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

25. A high power gas discharge laser producing laser output light pulses of high energy density comprising:
a laser output light pulse beam optical track having a plurality of modular components arranged in order from a laser light source to a laser system output port and defining a laser output light pulse beam path having a single centerline axis;
an optical module within the optical track or outside the laser system output port expanding the laser output light pulse beam temporally;
an optical element comprising a beam expander expanding the beam geometrically intermediate the laser light source and the optical module expanding the output laser light pulse beam temporally.

26. The apparatus of claim 25 further comprising:
the optical element comprises a beam expander expanding the laser output light pulse beam along the short axis of the laser output light pulse beam.

27. The apparatus of claim 25 further comprising:
the optical element comprises a lensed beam expander.

28. The apparatus of claim 26 further comprising:
the optical element comprises a lensed beam expander.

29. The apparatus of claim 25 further comprising:
the optical element comprises at least a part of a telescoping lens set forming an optical beam expander.

30. The apparatus of claim 26 further comprising:
the optical element comprises at least a part of a telescoping lens set forming an optical beam expander.

31. The apparatus of claim 27 further comprising:
the optical element comprises at least a part of a telescoping lens set forming an optical beam expander.

32. The apparatus of claim 28 further comprising:
the optical element comprises at least a part of a telescoping lens set forming an optical beam expander.

33. The apparatus of claim 29 further comprising:
the at least a part of a telescoping lens set comprises the entire telescoping lens set forming the optical beam expander located between adjacent optical modular components.

34. The apparatus of claim 30 further comprising:
the at least a part of a telescoping lens set comprises the entire telescoping lens set forming the optical beam expander located between adjacent optical modular components.

35. The apparatus of claim 31 further comprising:
the at least a part of a telescoping lens set comprises the entire telescoping lens set forming the optical beam expander located between adjacent optical modular components.

36. The apparatus of claim 32 further comprising:
the at least a part of a telescoping lens set comprises the entire telescoping lens set forming the optical beam expander located between adjacent optical modular components.

37. The apparatus of claim 29 further comprising:
the at least a part of a telescoping lens set comprises a first part of the beam expander cooperating with at least a second part located in a subsequent optical module in the laser output light pulse beam optical track along the same optical centerline axis.

38. The apparatus of claim 30 further comprising:
the at least a part of a telescoping lens set comprises a first part of the beam expander cooperating with at least a second part located in a subsequent optical module in the laser output light pulse beam optical track along the same optical centerline axis.

39. The apparatus of claim 31 further comprising:
the at least a part of a telescoping lens set comprises a first part of the beam expander cooperating with at least a second part located in a subsequent optical module in the laser output light pulse beam optical track along the same optical centerline axis.

40. The apparatus of claim 32 further comprising:
the at least a part of a telescoping lens set comprises a first part of the beam expander cooperating with at least a second part located in a subsequent optical module in the laser output light pulse beam optical track along the same optical centerline axis.

41. The apparatus of claim 33 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

42. The apparatus of claim 34 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

43. The apparatus of claim 35 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

44. The apparatus of claim 36 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

45. The apparatus of claim 37 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

46. The apparatus of claim 38 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

47. The apparatus of claim 39 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

48. The apparatus of claim 40 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

49. A high power gas discharge laser producing laser output light pulses of high energy density comprising:
a laser output light pulse beam optical track having a plurality of modular components arranged in order from a laser light source to a laser system output port and defining a laser output light pulse beam path having a single centerline axis;
an optical module within the optical track comprising a wavelength and/or bandwidth detector;
an optical element intermediate the laser light source and the optical module.

50. The apparatus of claim 49 further comprising:
the optical element comprises a beam expander expanding the laser output light pulse beam along the short axis of the laser output light pulse beam.

51. The apparatus of claim 49 further comprising:
the optical element comprises a lensed beam expander.

52. The apparatus of claim 50 further comprising:
the optical element comprises a lensed beam expander.

53. The apparatus of claim 49 further comprising:
the optical element comprises at least a part of a telescoping lens set forming an optical beam expander.

54. The apparatus of claim 50 further comprising:
the optical element comprises at least a part of a telescoping lens set forming an optical beam expander.

55. The apparatus of claim 51 further comprising:
the optical element comprises at least a part of a telescoping lens set forming an optical beam expander.

56. The apparatus of claim 52 further comprising:
the optical element comprises at least a part of a telescoping lens set forming an optical beam expander.

57. The apparatus of claim 53 further comprising:
the at least a part of a telescoping lens set comprises the entire telescoping lens set forming the optical beam expander located between the laser light source and the optical module aligned with the optical centerline axis.

58. The apparatus of claim 54 further comprising:
the at least a part of a telescoping lens set comprises the entire telescoping lens set forming the optical beam expander located between the laser light source and the optical module aligned with the optical centerline axis.

59. The apparatus of claim 55 further comprising:
the at least a part of a telescoping lens set comprises the entire telescoping lens set forming the optical beam expander located between the laser light source and the optical module aligned with the optical centerline axis.

60. The apparatus of claim 56 further comprising:
the at least a part of a telescoping lens set comprises the entire telescoping lens set forming the optical beam expander located between the laser light source and the optical module aligned with the optical centerline axis.

61. The apparatus of claim 53 further comprising:
the at least a part of a telescoping lens set comprises a first part of the beam expander cooperating with at least a second part located within the optical module aligned with the optical centerline axis.

62. The apparatus of claim 54 further comprising:
the at least a part of a telescoping lens set comprises a first part of the beam expander cooperating with at least a second part located within the optical module aligned with the optical centerline axis.

63. The apparatus of claim 55 further comprising:
the at least a part of a telescoping lens set comprises a first part of the beam expander cooperating with at least a second part located within the optical module aligned with the optical centerline axis.

64. The apparatus of claim 56 further comprising:
the at least a part of a telescoping lens set comprises a first part of the beam expander cooperating with at least a second part located within the optical module aligned with the optical centerline axis.

65. The apparatus of claim 57 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

66. The apparatus of claim 58 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

67. The apparatus of claim 59 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

68. The apparatus of claim 60 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

69. The apparatus of claim 61 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

70. The apparatus of claim 62 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

71. The apparatus of claim 63 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

72. The apparatus of claim 64 further comprising:
a plurality of aligning mechanisms aligning at least one optical element to a first and a second axis of the laser output pulse beam, the first and second axes being generally orthogonal to each other and orthogonal to the optical centerline axis, and also aligning the at least one optical element along the optical centerline axis.

73. A high power gas discharge laser producing laser output light pulses of high energy density comprising:
a laser output light pulse beam optical track having a plurality of modular components arranged in order from a laser light source to a laser system output port and defining a laser output light pulse beam path having a single centerline axis;
an output coupler optical element having a partially reflective surface facing a resonance cavity of the gas discharge laser and forming a front cylindrical lens of a beam expander;
a rear cylindrical lens of the beam expander.

74. The apparatus of claim 73 further comprising:
the rear cylindrical lens is contained in an optical module in the optical track downstream of the output coupler optic.

75. The apparatus of claim 73 further comprising:
the rear cylindrical lens is contained in a beam expander assembly housing nested within a flexible inter-module vibration isolation connecting element between a first optical module and a second optical module and rigidly attached to either the first optical module or the second optical module but not to both the first optical module and the second optical module.

76. The apparatus of claim 74 further comprising:
the rear cylindrical lens is contained in a beam expander assembly housing nested within a flexible inter-module vibration isolation connecting element between a first optical module and a second optical module and rigidly attached to either the first optical module or the second optical module but not to both the first optical module and the second optical module.

77. The apparatus of claim 73 further comprising:
a wavemeter beam splitter intermediate the front cylindrical lens and the rear cylindrical lens.

78. The apparatus of claim 74 further comprising:
a wavemeter beam splitter intermediate the front cylindrical lens and the rear cylindrical lens.

79. The apparatus of claim 75 further comprising:
a wavemeter beam splitter intermediate the front cylindrical lens and the rear cylindrical lens.

80. The apparatus of claim 76 further comprising:
a wavemeter beam splitter intermediate the front cylindrical lens and the rear cylindrical lens.

81. A high power gas discharge laser producing laser output light pulses of high energy density comprising:
a laser output light pulse beam optical track having a plurality of modular components arranged in order from a laser light source to a laser system output port and defining a laser output light pulse beam path having a single centerline axis;
a beam expander comprising:
a front lens rigidly mounted in the output laser light pulse beam path;
a rear lens rigidly mounted in the output laser light pulse beam path; and
a moveable lens intermediate the front and rear lenses positionable to vary the magnification of the beam expander.

82. The apparatus of claim 81 further comprising:
the moveable lens is positioned to a desired position and not actively controlled during normal operation of the laser system.

83. The apparatus of claim 81 further comprising:
the moveable lens is actively controlled during normal operation of the laser system.
